(19) United States
(12) Patent Application Publication
(10) Pub. No.: US 2023/0333999 A1
(43) Pub. Date: Oct. 19, 2023

(54) MAXIMIZING ON-CHIP DATA REUSE IN COMPUTE IN MEMORY AND COMPUTE NEAR MEMORY ARCHITECTURES

(71) Applicant: Intel Corporation, Santa Clara, CA (US)

(72) Inventors: Om Ji Omer, Bangalore (IN); Anirud Thyagharajan, Bengaluru (IN); Sreenivas Subramoney, Bangalore (IN)

(21) Appl. No.: 18/339,762

(22) Filed: Jun. 22, 2023

(51) Int. Cl. G06F 13/28

(52) U.S. Cl. CPC G06F 13/28

(57) ABSTRACT

Systems, apparatuses and methods may provide for technology that includes a chip having a memory structure including compute hardware, a plurality of address decoders coupled to the compute hardware, and a hierarchical interconnect fabric coupled to the plurality of address decoders, and direct memory address (DMA) hardware positioned adjacent to one or more of the plurality of address decoders, wherein the DMA hardware is to conduct on-chip transfers of intermediate state data via the hierarchical interconnect fabric. Additionally, the chip may include logic to allocate address space in the chip to intermediate state data and store the intermediate state data to the allocated address space.

### TECHNICAL FIELD

Embodiments generally relate to the transfer of data during artificial intelligence (AI) compute operations. More particularly, embodiments relate to maximizing on-chip data reuse in compute in memory (CiM) and compute near memory (CnM) architectures that perform AI compute operations.

### BACKGROUND

A neural network (NN) can be represented as a structure that is a graph of several neuron layers flowing from one layer to the next. During AI/DNN (deep neural network) model execution, intermediate feature maps (e.g., tensors) are created at each layer and consumed in subsequent layers. Storing feature maps off-chip and re-fetching the feature maps during model execution may have a negative impact on power consumption and/or performance.

### BRIEF DESCRIPTION OF THE DRAWINGS

The various advantages of the embodiments will become apparent to one skilled in the art by reading the following specification and appended claims, and by referencing the following drawings, in which:

FIG. 1 is a block diagram of an example of a chip that includes direct memory access (DMA) hardware to conduct on-chip transfers of intermediate state data according to an embodiment;

FIG. 2 is an illustration of an example of a sub-array address map and a system address map according to an embodiment;

FIG. 3 is an illustration of an example of a system view of tensor allocation and a memory sub-array view of buffer allocation according to an embodiment;

FIGS. 4A and 4B are flowcharts of examples of methods of conducting tensor memory mapping according to embodiments;

FIG. 5 is an illustration of an example of active tensors at different layer processing stages;

FIG. 6A is an illustration of an example of a linearized representation of a directed acyclic graph (DAG) and associated address allocation according to an embodiment;

FIG. 6B is an illustration of an example of a linearized representation of a DAG and associated address allocation according to another embodiment;

FIG. 7A is an illustration of an example of a process flow to allocate address space in a chip to intermediate state data according to an embodiment;

FIG. 7B is an illustration of an example of pseudo code to set layer attributes according to an embodiment;

FIG. 7C is an illustration of an example of a first portion of pseudo code to assign polarity to long-term tensors according to an embodiment;

FIG. 7D is an illustration of an example of a second portion of pseudo code to assign polarity to long-term tensors according to an embodiment;

FIG. 7E is an illustration of an example of a first portion of pseudo code to manage tensor address allocations according to an embodiment;

FIG. 7F is an illustration of an example of a second portion of pseudo code to manage tensor address allocations according to an embodiment;

FIG. 7G is an illustration of an example of a third portion of pseudo code to manage tensor address allocations according to an embodiment;

FIG. 7H is an illustration of an example of a fourth portion of pseudo code to manage tensor address allocations according to an embodiment;

FIG. 8 is a set of schematic diagrams of an example of local DMA hardware according to an embodiment;

FIG. 9 is a schematic diagram of an example of a multi-channel DMA engine according to an embodiment;

FIG. 10 is an illustration of an example of pseudo code to conduct spatial data flow optimizations according to an embodiment;

FIG. 11 is an illustration of an example of hierarchically aligned spatial data flows between output state data and input state data according to an embodiment;

FIG. 12 is a chart of an example of data transfer reduction results according to an embodiment;

FIG. 13 is a chart of an example of performance speedup results according to an embodiment;

FIG. 14 is a chart of an example of bandwidth performance results according to an embodiment;

FIG. 15 is a flowchart of an example of a method of operating DMA hardware according to an embodiment;

FIG. 16 is a flowchart of an example of a method of operating a performance-enhanced computing system according to an embodiment;

FIG. 17 is a block diagram of an example of a performance-enhanced computing system according to an embodiment;

FIG. 18 is an illustration of an example of a semiconductor package apparatus according to an embodiment;

FIG. 19 is a block diagram of an example of a processor according to an embodiment; and

FIG. 20 is a block diagram of an example of a multi-processor based computing system according to an embodiment.

### DETAILED DESCRIPTION

Compute in memory (CiM) and compute near memory (CnM) architectures are pursued in DNN-based workloads due to significant energy savings and performance gains that address data access issues. During AI/DNN model execution, intermediate feature maps (e.g., tensors, intermediate state data) are created at each layer and consumed in subsequent layers. Given the relatively high cost of off-chip data accesses (e.g., accesses to on-die or off-die memories external to on-chip (CiM/CnM enabled) memory), on-chip data reuse of intermediate feature maps can provide enhanced performance (e.g., in off-die bandwidth-constrained scenarios) and energy savings as compared to storing feature maps off-die and re-fetching the feature maps from off-die memory. Reusing feature map data, however, within on-chip memories has the following challenges:
Limited capacity of on-chip memories may restrict the ability to allocate buffers for every intermediate feature map across a wide range of AI workloads.
With distributed computing for CiM/CnM, feature maps are produced and kept locally in parts (e.g., “tiles”) in each (or few) memory sub-arrays. In subsequent layers that consume these feature maps, however, the same local compute cores may not fully consume all of the locally produced data tiles, requiring on-chip data movement across memory sub-arrays.
Movement of data at the input/output (I/O) interface (e.g., performing read/write operations by an external agent) can create bandwidth bottlenecks at the I/O interface and consume excessive energy over long routes/wires.

The technology described herein provides hardware support for in-memory direct memory access (DMA) operations. The technology described herein also provides an enhanced compiler (e.g., dataflow optimizer) framework addressing the above-mentioned challenges toward achieving improved performance and energy savings at the end-to-end workload level.

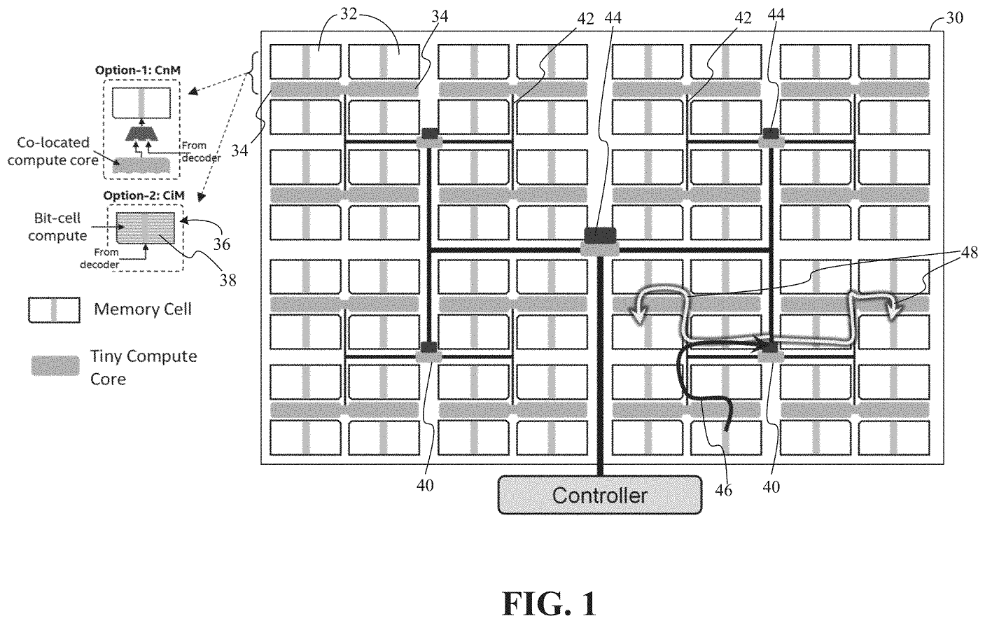

FIG. 1 shows a chip 30 (e.g., semiconductor die, package and/or system on chip/SoC) in which a memory structure includes either a plurality of memory cell sub-arrays 32 and compute hardware 34 (e.g., a plurality of compute cores) corresponding to the plurality of memory cell sub-arrays 32 (e.g., in a CnM configuration) or a memory bit-cell array 36 and compute hardware 38 (e.g., bit-cell compute) incorporated into the memory bit-cell array 36 (e.g., in a CiM configuration). The chip 30 also includes a plurality of address decoders 40 coupled to the compute hardware 34, 38 and a hierarchical interconnect fabric 42 coupled to the plurality of address decoders 40. Additionally, the chip 30 includes DMA hardware 44 positioned adjacent to one or more of the plurality of address decoders 40, wherein the DMA hardware 44 conducts on-chip transfers of intermediate state data (e.g., inter-layer data associated with a neural network/NN) via the hierarchical interconnect fabric 42. For example, the on-chip transfers might include a read operation along an on-chip data path 46 and a write operation along data paths 48.

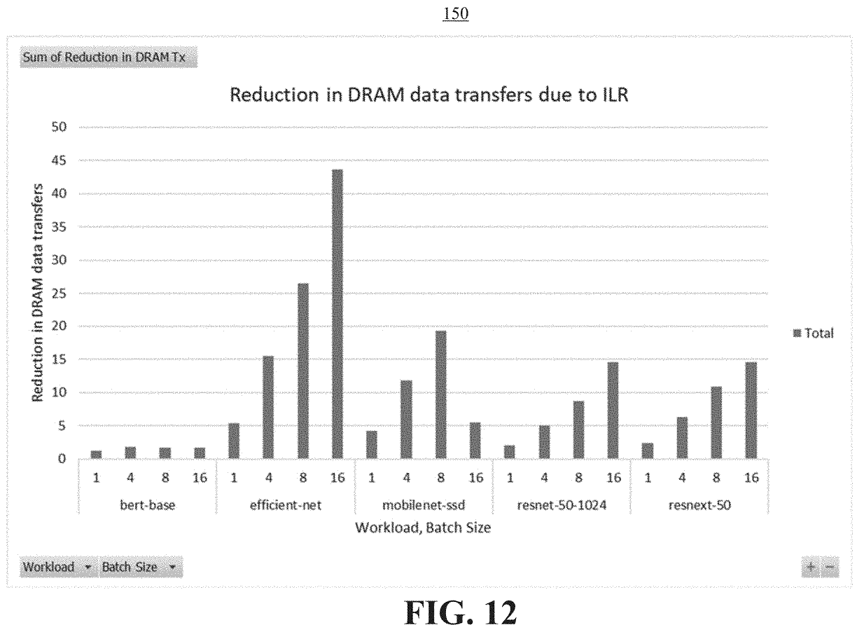

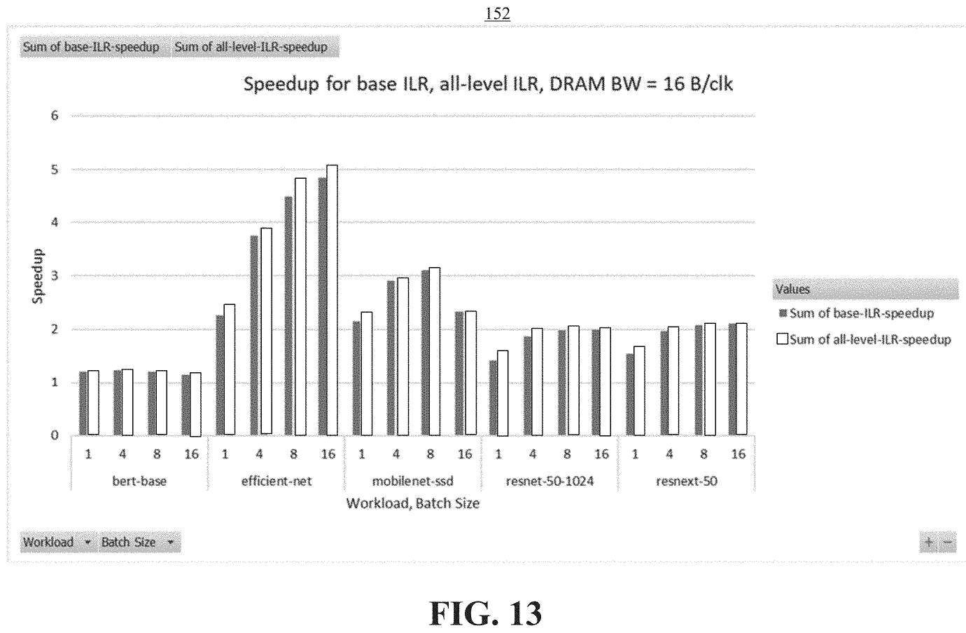

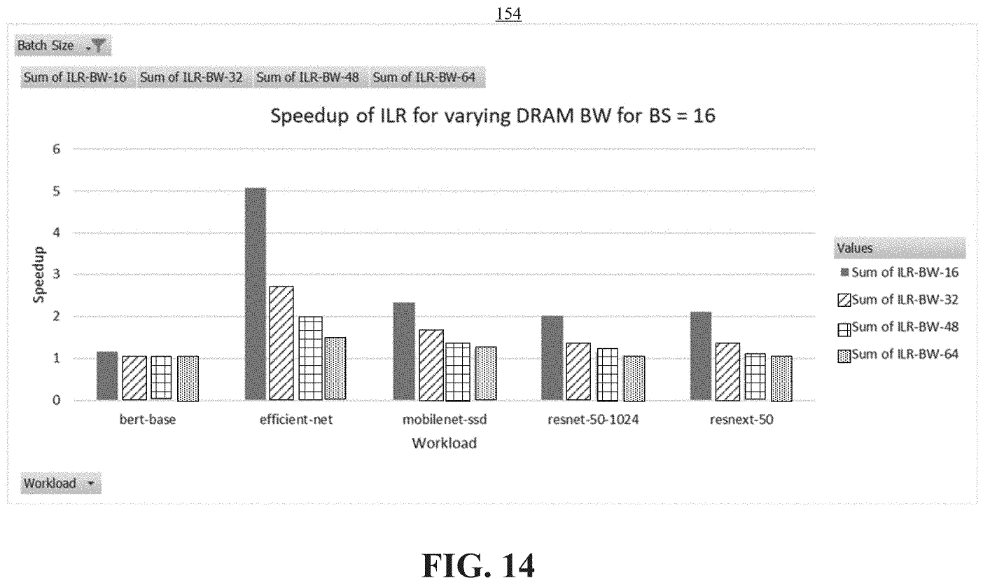

The illustrated architecture provides several advantages over conventional solutions. For example, with on-chip inter-layer data reuse across a variety of AI workloads, a substantial reduction in off-die data accesses and performance improvement in bandwidth-constrained scenarios is achieved, as shown in a chart 150 (FIG. 12, discussed in greater detail below) and a chart 152 (FIG. 13, discussed in greater detail below). Moreover, additional DMA support at inner levels in the memory hierarchy (e.g., 2nd level onwards) provides a further increase in execution speeds, as shown in a chart 154 (FIG. 14, discussed in greater detail below). Additionally, a tensor mapping and address allocation scheme as described herein ensures maximum utilization of on-chip memory, while data flow optimization techniques enable on-chip data reuse with minimal data movement (e.g., avoiding relatively long routes).

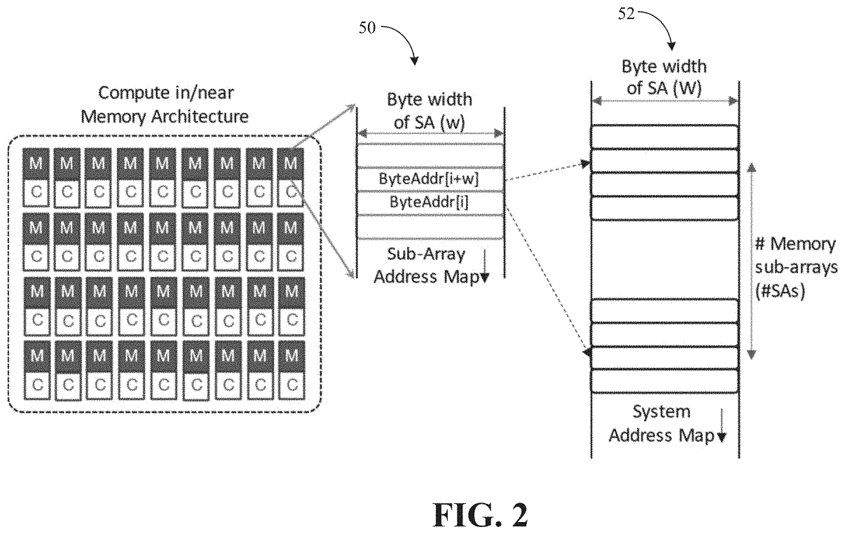

FIG. 2 demonstrates that memory storage in a CiM/CnM architecture may be viewed in two modes: 1) a memory sub-array address map 50 mode, and 2) a system address map 52 mode. Using address interleaving, the system address map 52 is constructed from each memory sub-array. The interleaving provides a uniform distribution of the address space to each memory sub-array if allocated contiguously in the system view (e.g., achieving fair memory allocation to each compute core towards most efficient execution).

Tensor Mapping and Address Allocation—Address Space Management

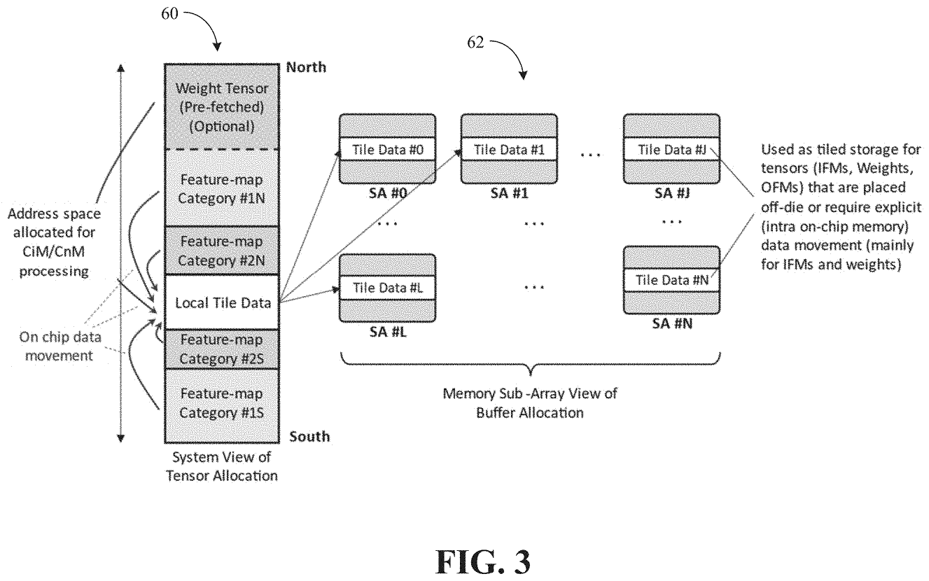

With continuing reference to FIGS. 2 and 3, a system view 60 of tensor allocation demonstrates that system address space allocated for the CiM/CnM architecture is used to store 1) pre-fetched weight data (e.g., in scenarios where the inference model instance is shared across multiple inputs/queries over a period of time), 2) intermediate feature-maps (e.g., intermediate state data that is reused across layers), and 3) local tile data. In many scenarios, tiled data for an output feature map (OFM) is stored in the space allocated to the current layer feature map. Such an approach avoids explicit data movement (e.g., flushes) of OFM tile data.

Additionally, a memory sub-array view 62 of buffer allocation demonstrates that the buffer allocation strategy minimizes memory fragmentation and provides maximum allocation size for tile data at each layer. For example, after deducting persistent data usage (e.g., pre-fetching weight data), the remaining memory space is used for feature maps and tile data storage.

In one example, feature map allocation is divided into two categories. Category #1 is used for long reuse buffers (e.g., feature-maps) and can fall on two ends/polarities (e.g., north/upper or south/lower) of the address space. Category #2 buffers are used for feature-maps that are produced and consumed in consecutively executed NN layers.

Tensor Mapping and Address Allocation—Tensor Memory Mapping

In an embodiment, tensor residencies are expressed as one of two modes (RESIDE_ON_CHIP, RESIDE_OFF_CHIP). Inputs to every layer include IFMs (input feature maps) and weights, and the outputs include OFMs (output feature maps).

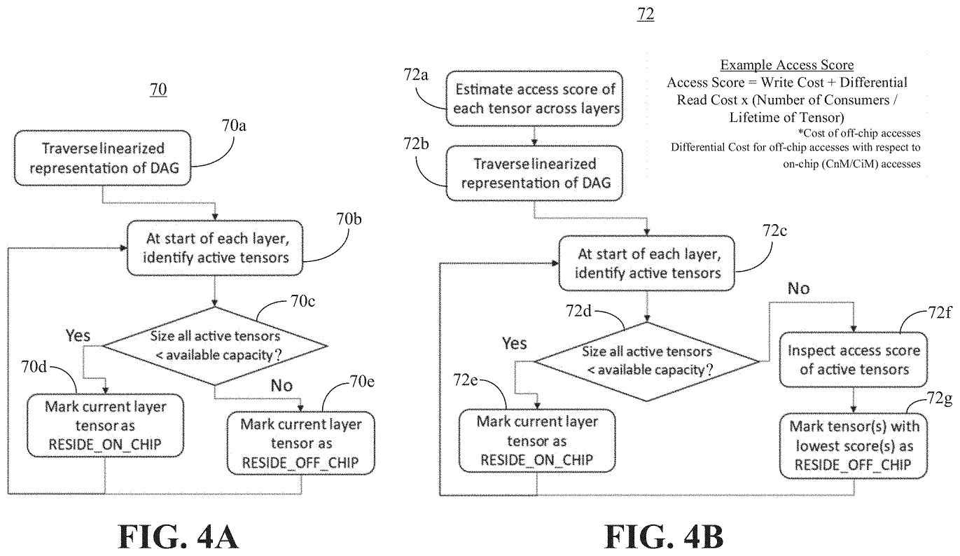

Input and output operands to the neural network model may be defined as I₀ and O_{N-1}, respectively. Without loss of generality, each neural network can be expressed as a Directed Acyclic Graph (DAG). In one example, an architecture aware “greedy” algorithm runs through a linearized traversal of the DAG from source I₀ to destination O_{N-1} and returns per-layer tensor residencies (e.g., residency data) and per-tensor available memory capacity (e.g., memory availability). Stages of the procedure are described below:
A user-driven flag determines whether weights are assumed to be prefetched on-chip. Such a solution is becoming increasingly applicable in server scenarios, where accelerators are dedicatedly used for certain neural network models, and it may be advantageous to store these weights on-chip and avoid data re-fetches across different input batches. On the basis of this flag, the procedure attempts to place the weights on-chip for each layer and updates the available memory capacity and layer-wise weight tensor residencies. If the weights of certain layers do not fit on-chip, their respective residencies are marked as RESIDE_OFF_CHIP.
With continuing reference to FIGS. 4A and 4B, a method 70 (70a-70e, e.g., implemented in logic instructions, configurable logic, fixed-functionality hardware logic, etc., or any combination thereof) demonstrates that, for each layer, a binary flag is greedily determined based on whether output feature-maps (OFMs) of the layer can be placed on-chip or not. In another example, a method 72 (72a-72g, e.g., implemented in logic instructions, configurable logic, fixed-functionality hardware logic, etc., or any combination thereof) demonstrates that a buffer is defined as active if allocated on on-chip memory and remains active until the last NN layer that consumes the feature-map data is done processing. After the last NN layer execution that consumes the buffer, buffer memory is freed and added to total available memory for next layers. As already noted, if the feature maps of certain layers do not fit on-chip, their respective residencies are marked as RESIDE_OFF_CHIP.
   More particularly, processing block 70a of the method 70 traverses a linearized representation of the DAG and block 70b identifies active tensors at the start of each layer. A determination is made at block 70c as to whether all active tensors are less than the available capacity. If so block 70d marks the current layer tensor as RESIDE_ON-CHIP and the method 70 returns to block 70b. Otherwise, block 70e marks the current layer tensor as RESIDE_OFF_CHIP and the method returns to block 70b.

By contrast, processing block 72a of the method 72 estimates an access score of each tensor across the layers of the NN. In one example, the access score is a function of the write cost, the differential read cost, the number of consumers, and the lifetime of the tensor). Block 72b traverses a linearized representation of the DAG and block 72c identifies active tensors at the start of each layer. A determination is made at block 72d as to whether all active tensors are less than the available capacity. If so, block 72e marks the current layer tensor as RESIDE_ON-CHIP and the method 72 returns to block 72c. Otherwise, block 72f inspects the access score of the active tensors and block 72g marks the tensor(s) with the lowest score(s) as RESIDE_OFF_CHIP. While the tensors with lowest score(s) are marked as RESIDE_OFF_CHIP, other active tensors whose cumulative size is well within available on-chip memory capacity are marked as RESIDE_ON_CHIP. Thus, the method 72 may be considered to be less “naïve” than the method 70. The residual memory capacity (e.g., after allocating the above buffers) is used to store tiled data for each layer in the intra-layer data flow optimization process.

Tensor Mapping and Address Allocation—Tensor Address Allocation

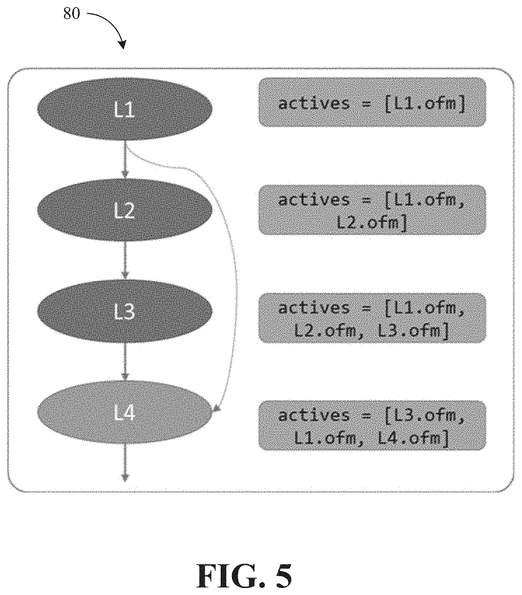

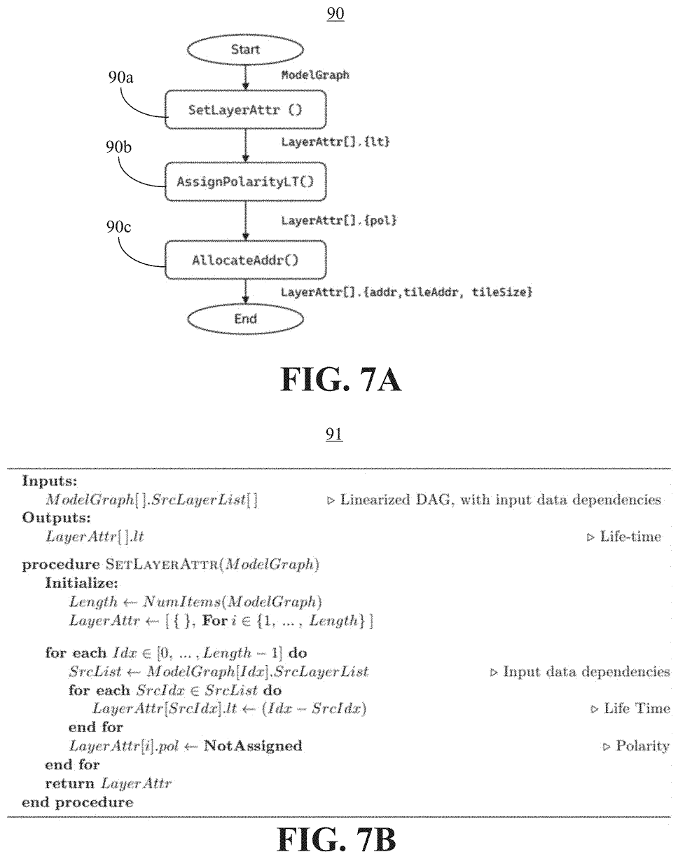

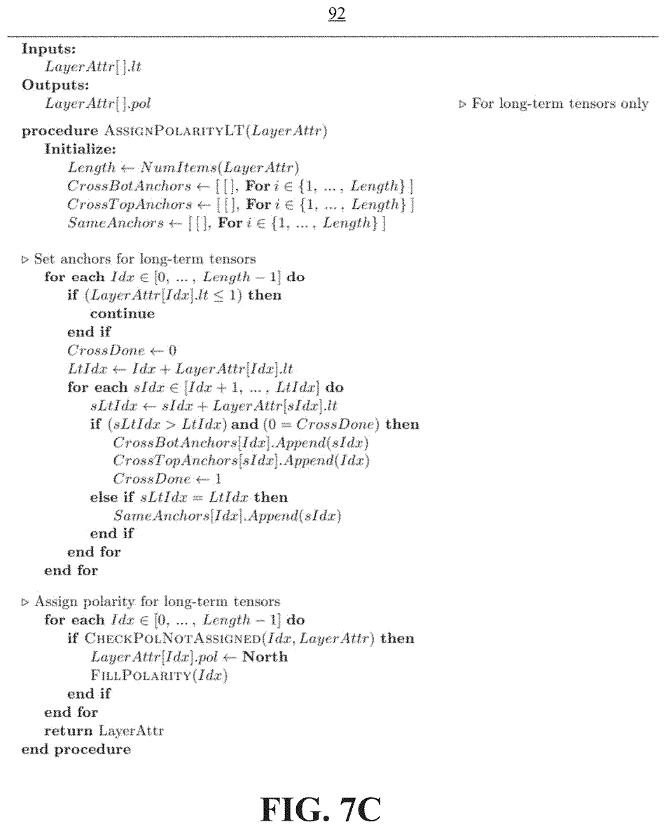

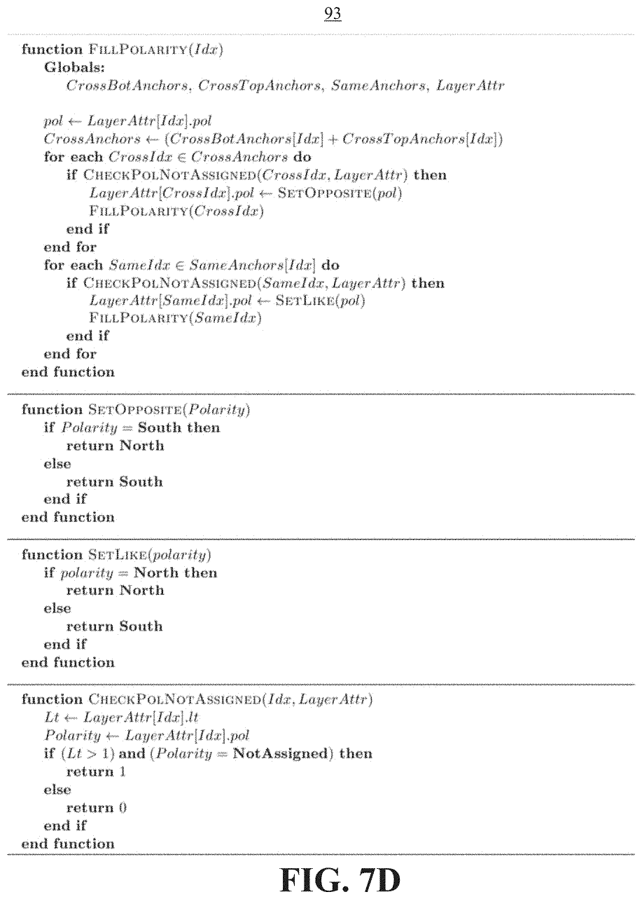

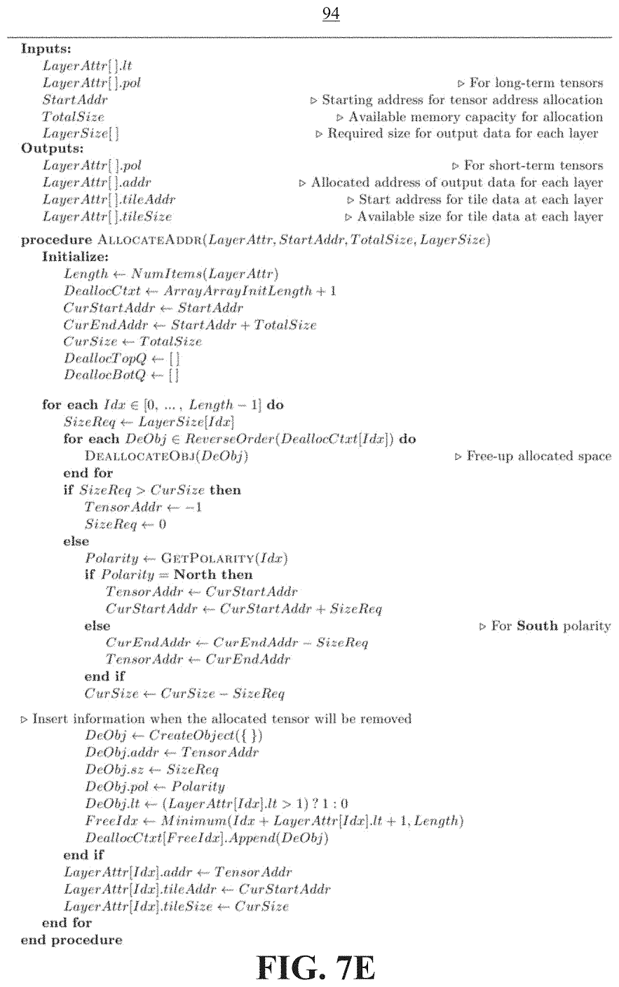

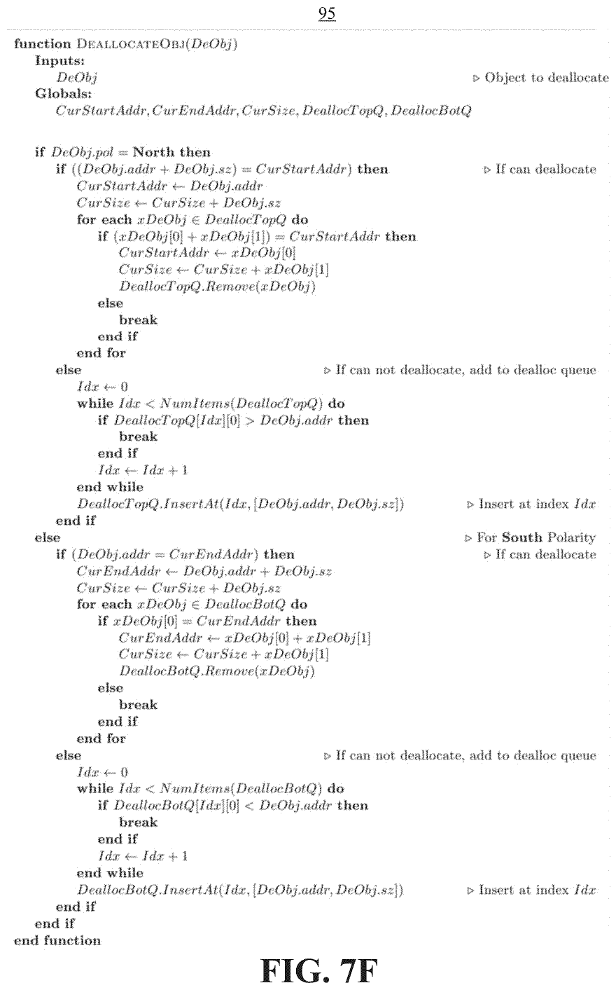

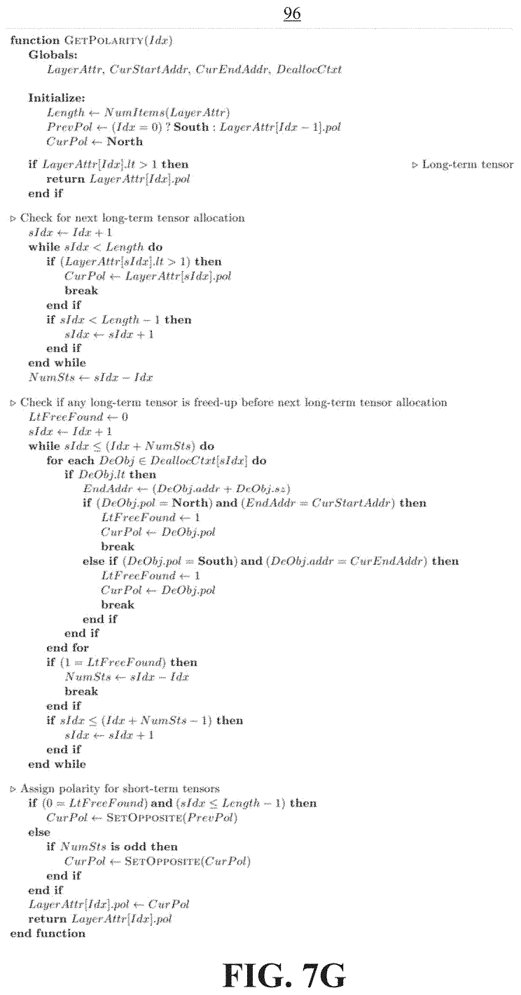

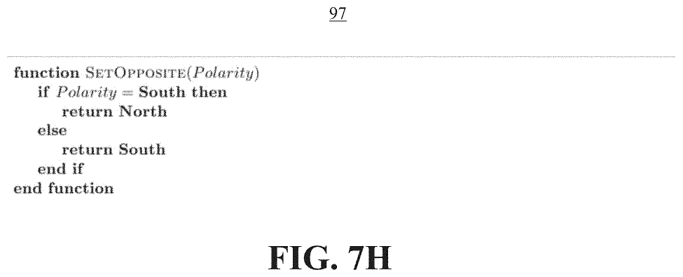

To minimize memory fragmentation due to allocation and deallocation procedures at each layer, an address (e.g., in the system address map) for each active tensor (e.g., feature-map allocated into CiM/CnM on-chip memory) is assigned as described herein. Embodiments maximize space allocation for feature-map and tile-data storage towards efficient execution:
Addresses for pre-fetched weight tensors are first allocated (e.g., if exercised by the user), wherein that start address and remaining allocated size is updated before proceeding.
FIG. 5 demonstrates that through a linearized traversal of a DAG 80, tensor occupancies at each the processing stage of each layer are tagged. In one example, each tensor is divided into two categories based on lifetime: 1) the Long-Term (LT) category is assigned to tensors whose lifetime is more than one, 2) the Short-Term (ST) is assigned to those tensors that are produced and then consumed in very next layer.
With continuing reference to FIGS. 7A-7H, a dual-side stack implementation may be used to allocate tensor addresses. The dual-side stack implementation minimizes memory fragmentation, maximizes space allocation for feature-maps and tile-data storage, and provides more efficient execution. Allocation from the lower address side is referred as “North polarity allocation”, while allocation from higher address side as “South pole allocation”. As best seen in FIG. 7A, a process flow 90 (90a-90c) includes a first procedure 90a to set layer attributes, a second procedure 90b to assign polarities to long-term sensors, and a third procedure 90c to manage address allocations. As best seen in FIG. 7B attribute pseudo code 91 sets neural network layer attributes. As best seen in FIG. 7C, a first portion 92 of long-term pseudo code identifies tensors with long-term (LT) polarity (e.g., North or South) based on residency data (e.g., lifetimes) and assigns polarities for long-term tensors. The idea of anchor frames is to identify instances where allocation and deallocation of two tensors is either interleaved (e.g., cross anchors) or have common deallocation point (e.g., same anchors). Tensors related to one another as cross anchors are expected to have opposite polarity, so that the tensors to not block allocation/deallocation of each other. While all tensors in the “same anchor” relationship are expected to have the same polarity for the similar reasons as state above. As best seen in FIG. 7D, a second portion 93 of the long-term pseudo code can include various functions (e.g., FILLPOLARITY( ), SETOPPOSITE( ), SETLIKE( ), CHECKPOLNOTASSIGNED( )) to facilitate the assignment of polarities to long-term tensors.
As best seen in FIG. 7E, a first portion 94 of allocation management pseudo code manages the assignment of tensor (e.g., output data for each neural network layer) addresses in order per linearized representation and tensor polarity. As best seen in FIG. 7F, a second portion 95 of the allocation management pseudo code uses a deallocation function (e.g., DEALLOCATEOBJ( )) to reclaim tensor addresses. The second portion 95 of the allocation management pseudo code demonstrates that at the end of the lifetime of a tensor, address space is reclaimed if tensors of the same polarity that are allocated later complete their lifetime, otherwise a hole in the address space is created and the hole lasts until that moment in time. As best seen in FIG. 7G, a third portion 96 of the allocation management pseudo code uses a polarity function (e.g., GETPOLARITY( )) to obtain polarity information, check for the next long-term tensor allocation, check if any long-term tensor is freed-up before the next long-term tensor allocation, and assign polarities for short-term tensors. As best seen in FIG. 7H, a fourth portion 97 of the allocation management pseudo code uses an opposite polarity function (e.g., SETOPPOSITE( )) to set the opposite polarity.
At each layer processing stage, remaining un-allocated address space is used to store tile-data.

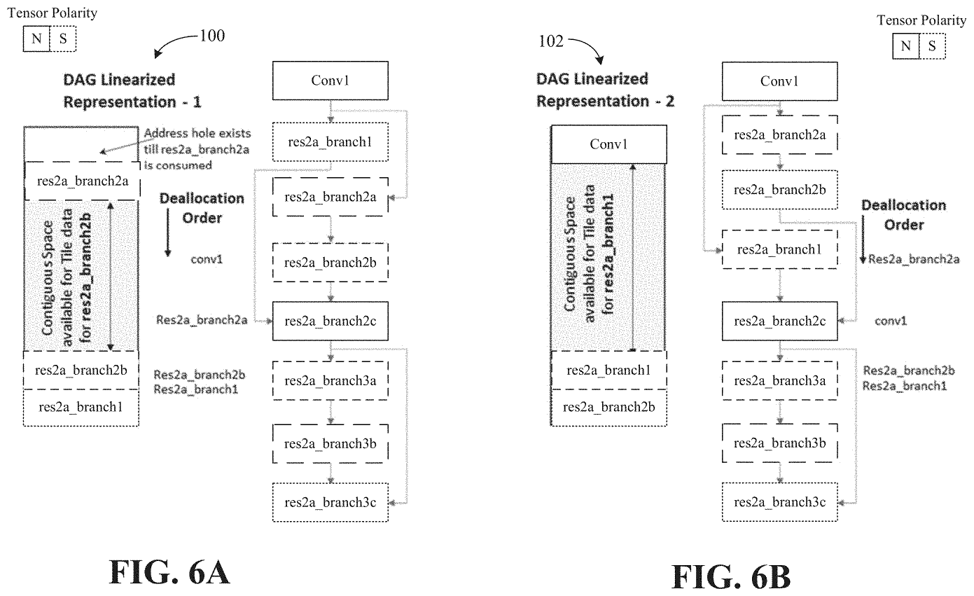

Turning now to FIGS. 6A and 6B, among many canonical linearized representations (e.g., topological sorts) of a given DAG, the representation having the lowest number of hole(s) may be selected. For example, a first representation 100 introduces a hole in the address space during res2abranch2c execution, whereas a second representation 102 fully utilizes the entire address space throughout the inference execution. Thus, the second representation 102 can be selected over the first representation 100. In special scenarios, holes could be used for subsequent tensor address allocation size and lifetime criterion are met.

In-Memory (e.g., Intra) Support for Local DMA

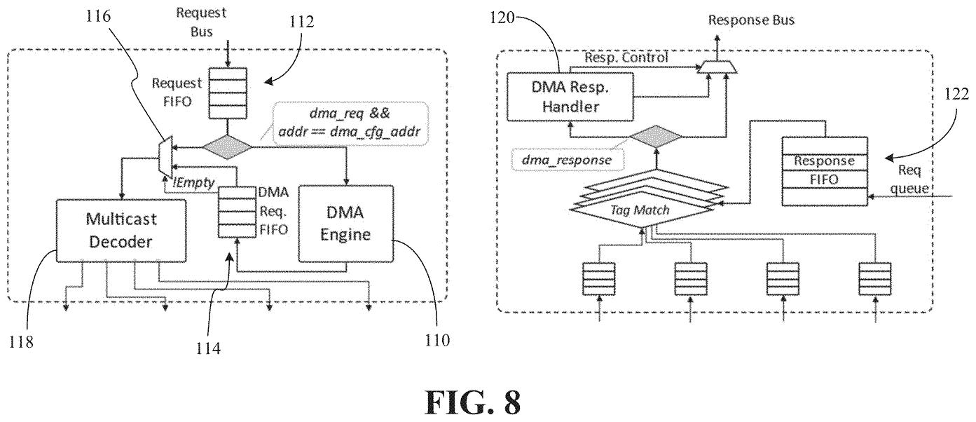

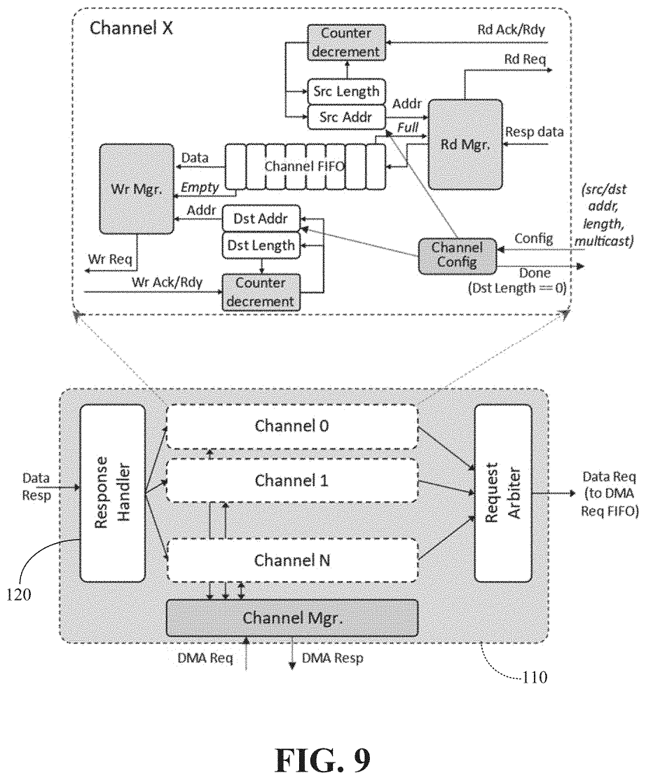

Turning now to FIGS. 8-9, the technology described herein also provides hardware support for local DMA (e.g., at a given decoder level) that can perform data movement across memory units associated with that decoder level. As best shown in FIG. 8, a DMA engine 110 taps on a request first-in-first-out (FIFO) 112 to determine whether a DMA configuration request (e.g., using a sideband signal) for that decoder level (e.g., through address decode) has been received. Upon receiving a DMA configuration request, the DMA engine 110 starts issuing read and write requests, which get queued in a DMA request FIFO 114. Arbitration logic 116 selects between DMA data requests and upstream data requests at each (e.g., valid) clock stage to push the selected request to the decoder circuitry 118.

Responses received by a DMA response handler 120 from the inner decoder level are either passed-through to the next (e.g., outer) decoder level or sent to the decoder engine based on a DMA tag bit set in a response FIFO 122 at the time of request generation. Responses to the DMA engine 110 are appropriately handled by read/write managers. Once all the data movements associated with a DMA configuration request are completed, the DMA engine 110 issues a response command for an upstream configuration request to the next (e.g., outer) decoder level.

Inter-Layer Spatial Data Flow Optimization—Overview

Embodiments provide a framework to obtaining an optimal spatial data flow (e.g., the feature-map data of a layer) for a distributed memory (e.g., CnM/CiM) architecture using local DMA capability for inter-memory data transfers and inter-layer data reuse (e.g., feature maps). First, a taxonomy to obtain an optimal data flow for CnM/CiM architecture with multicast capability at each decoder level in the memory hierarchy will be provided, followed by a procedure to find the optimal spatial data flow, and a procedure to identify decoder levels (e.g., in the memory hierarchy) with DMA capability that achieves best trade off between performance and hardware complexity.

Inter-Layer Spatial Data Flow—Taxonomy

In general, multiple tiles are grouped into a “super tile”, which constitutes a quantum of work that is executed simultaneously on the memory architecture. More particularly, IFM tiles and weight data tiles may be grouped individually to form an “IFM super tile” and a “weight super tile”. Based on NN layer parameters and compiler strategy for optimal data flows, an IFM super tile may contain one or more tiles along spatial (I chunks) and input channel (Ic chunks) dimensions. Similarly, a weight super-tile contains one or more tiles along input channel (Ic chunks) and output channel/filter (Oc chunks) dimensions. IFM and weight super-tiles are divided hierarchically such that the product of #1 chunks, #Ic chunks, and #0c chunks for a fan-out at any given level in the memory hierarchy is equal to total number of computing cores under the one fan-out at that hierarchy. In other words, division factors div I, div Ic, and div Oc (e.g., for I chunks, Ic chunks, and Oc chunks, respectively) at a given hierarchy level are chosen in such a way that the product of all three division factors is equal to number of fan-outs at that hierarchy level, to efficiently parallelize computations across N nodes. Thus, chunks at any level are the cumulative product of the divs for all levels below the level in question.

Inter-Layer Spatial Data Flow—Optimizing Tensor Spatial Layout

Assuming hardware support for local DMA at each decoder stage in the memory hierarchy (e.g., CiM/CnM), the below procedure optimizes the spatial arrangement of the current layer to minimize data transfers over longer wires (e.g., maximize data transfers at innermost levels). Such an approach reduces the cost of data movement, achieving energy savings and lower latency (e.g., in bandwidth constraint scenarios).

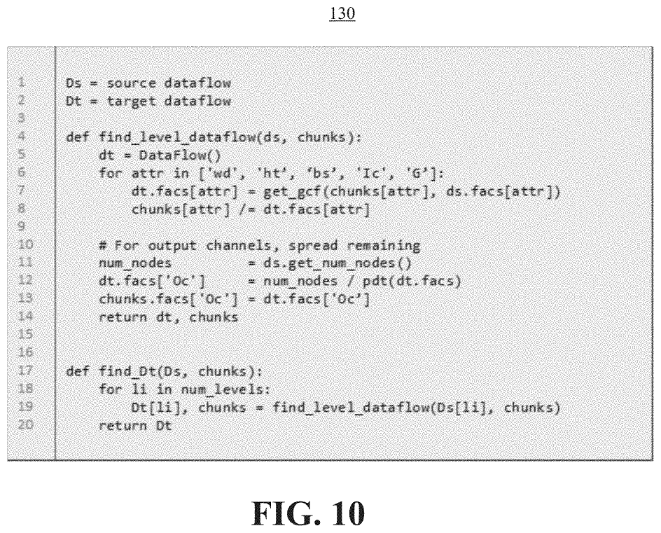

Turning now to FIG. 10, let Ds and Dt be the spatial dataflow of the source and target layers that produce and consume the same OFM, respectively. Ds represents (div_I, div_Ic, div_Oc) at each level for each dimension, while for Dt, only the cumulative chunks at the highest level (chunks_I, chunks_Ic, chunks_Oc) for the current layer are known. In data flow pseudo code 130, “PDT(array)” computes product of all elements in the array, “num_levels” refers to number of levels in the memory hierarchy, and “li=0” refers to outer most level in the memory hierarchy. Additionally, the “ds.get_num_nodes( ))” function provides a way to determine how many fan-outs at that (decoder) hierarchy (in the CiM/CnM) holds source intermediate data (e.g., input feature map). Thus, the data flow pseudo code 130 finds optimal factors at each hierarchy level (div_I, div_Ic, div_Oc) for the current layer, as follows:
For every dimension (except the output channels), the individual factors at each level Dt(div_I, div_Ic) are computed for the current layer by computing the maximum overlap of Dt(chunks_I, chunks_Ic) with Ds(div_I, div_Oc) at that level. In one example, this computation is done by computing the greatest common factor (GCF) of the two entities [lines 6-8]. The GCF also accommodates situations when the source tensor and the destination tensor are split across different number of nodes (input nodes !=output nodes).
At each level, a leftover factor (leftover from num_nodes) is computed [lines 13-15] and assigned to div_Oc because “Oc” (of the current layer) is the only dimension that does not have any correlation with the previous layer (e.g., the layer(s) that generate(s) inputs for the current layer).

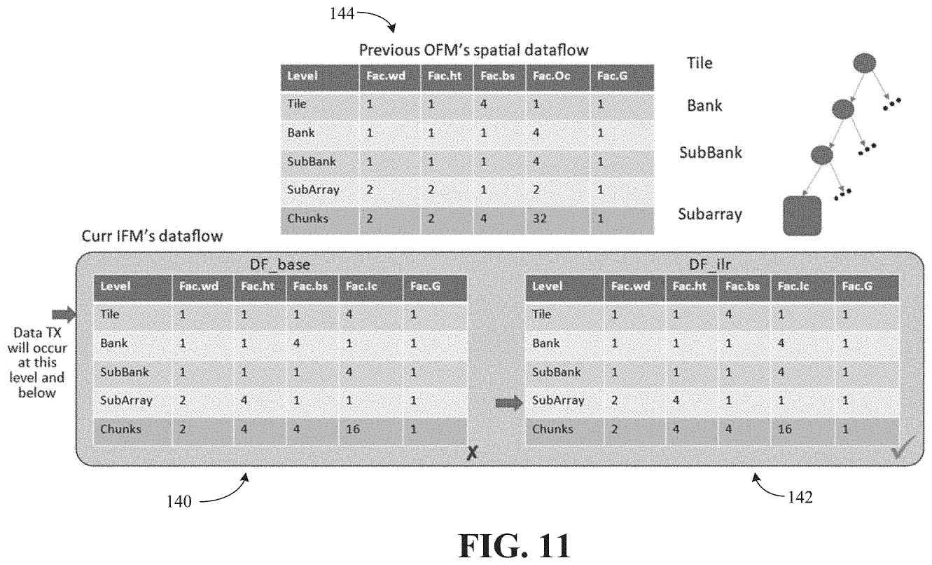

FIG. 11 shows a conventional IFM data flow 140 and an enhanced IFM data flow 142. The conventional IFM data flow 140 distributes the same chunks in such a way that does not align with a previous OFM data flow 144 (e.g., from a source layer). Applying the spatial data flow optimization technology described herein results in the enhanced IFM data flow 142, which aligns with the previous OFM data flow 144 at all levels in the memory hierarchy except the sub-array level. Thus, transfers only at the sub-array level are conducted and smaller tiles are transferred at inner memory levels (e.g., alleviating bottlenecks at outer levels).

Inter-Layer Spatial Data Flow—DMA Engine Placement

Placing a DMA engine at each decoder level in the memory hierarchy may add significant complexity (e.g., higher area and power). Accordingly, embodiments restrict the DMA hardware to a subset of locations corresponding to the plurality of address decoders (e.g., selectively picking decoder levels with DMA capability). The procedure detailed below identifies optimal levels to place DMA decoders for facilitating data transfers within distributed memory:
For each datatype, iterate from the outer-most level and search for the outer-most level where Ds[i] and Dt[i] do not match. Such a condition implies that intra-memory transfers would occur at levels <=i. Accordingly, for this datatype, it would be advantageous to place routers at level i. Given that architectural support for DMAs is present only at certain levels (S={lₖ}), the innermost level (lⱼ) is selected with DMA capability just higher than or equal to i (i.e., lⱼ=max ({lₖ∀lₖ∈S and lₖ≤i})).
For various combinations of supported levels of placing DMAs, the above operation is repeated for all layers in a neural network and a hardware configuration (e.g., including DMA capability at certain levels) is selected that provides the best performance (or objective function) for the least expended architectural resources (e.g., cost of supporting DMA capability).

### Example Results

Turning now to FIGS. 12-14, example results of the technology described herein. As best shown in FIGS. 12-13, a chart 150 of data transfer benefits and a chart 152 of performance speedup, respectively, demonstrate that data transfer reductions of up to 40× are obtained in some workloads (e.g., Efficient-Net). The data transfer reductions translate to a performance speedup of 1.2-5× in bandwidth constrained scenarios. As best shown in FIG. 14, a chart 154 that demonstrates the advantages of using inter-layer reuse (ILR) at inner levels in the memory hierarchy. Pre-allocating buffers that will reside on-chip also allows the dataflow optimizer to assess the memory capacity to be involved in intra-layer data flow optimization. This result is noticeable through the performance improvements offered by “base-MR” in the chart 152 (FIG. 13, e.g., base-ILR is assuming that data-transfers are allowed only at the highest level of the static random access memory/SRAM).

Spatial data flow alignment helps to reduce data transfers by aligning the desired spatial arrangement of feature maps to the expected arrangement hierarchically. Identifying the correct level of data transfers not only reduces data transfers, but also aids in architecture design—to assess the right level to place decoders to move data across nodes of the same hierarchy. Both of these advantages jointly contribute to the performance improvements visible between base-MR and all-levels-MR in the chart 152 (FIG. 13, e.g., Efficient-Net).

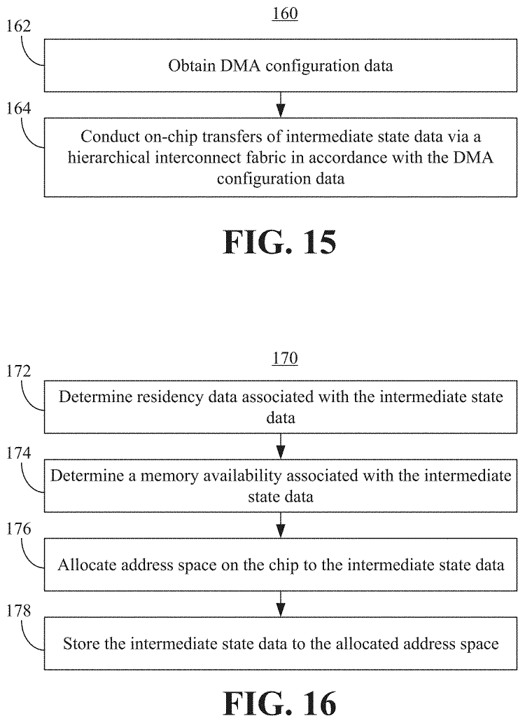

FIG. 15 shows a method 160 of operating DMA hardware. The method 160 may generally be implemented in DMA hardware such as, for example, the DMA hardware 44 (FIG. 1), already discussed. More particularly, the method may be implemented in configurable logic, fixed-functionality logic, or any combination thereof. Examples of configurable logic (e.g., configurable hardware) include suitably configured programmable logic arrays (PLAs), field programmable gate arrays (FPGAs), complex programmable logic devices (CPLDs), and general purpose microprocessors. Examples of fixed-functionality logic (e.g., fixed-functionality hardware) include suitably configured application specific integrated circuits (ASICs), combinational logic circuits, and sequential logic circuits. The configurable or fixed-functionality logic can be implemented with complementary metal oxide semiconductor (CMOS) logic circuits, transistor-transistor logic (TTL) logic circuits, or other circuits.

Illustrated processing block 162 provides for obtaining DMA configuration data (e.g., descriptor details, sideband signals). In an embodiment, the DMA configuration data is received by a chip including compute hardware, a plurality of address decoders coupled to the compute hardware, a hierarchical interconnect fabric coupled to the plurality of address decoders, and DMA hardware positioned adjacent to one or more of the plurality of address decoders. Block 164 conducts on-chip transfers of intermediate state data via the hierarchical interconnect fabric. In one example, the intermediate state data is inter-layer data associated with a neural network. The method 160 therefore enhances performance at least to the extent that conducting the on-chip transfers of intermediate state data reduces DRAM (dynamic random access memory) transfers and/or latency during operation.

FIG. 16 shows a method 170 of operating a performance-enhanced computing system. The method 170 may be implemented in one or more modules as a set of logic instructions (e.g., compiler software, data flow optimization software) stored in a machine- or computer-readable storage medium such as random access memory (RAM), read only memory (ROM), programmable ROM (PROM), firmware, flash memory, etc., in hardware, or any combination thereof.

Computer program code to carry out operations shown in the method 170 can be written in any combination of one or more programming languages, including an object oriented programming language such as JAVA, SMALLTALK, C++ or the like and conventional procedural programming languages, such as the “C” programming language or similar programming languages. Additionally, logic instructions might include assembler instructions, instruction set architecture (ISA) instructions, machine instructions, machine dependent instructions, microcode, state-setting data, configuration data for integrated circuitry, state information that personalizes electronic circuitry and/or other structural components that are native to hardware (e.g., host processor, central processing unit/CPU, microcontroller, etc.).

Processing block 172 determines residency data (e.g., per-layer residency data) associated with the intermediate state data (e.g., inter-layer data). In an embodiment, residency data indicates whether the intermediate state data in each layer is to reside on-chip or off-chip. Block 174 determines a memory availability (e.g., per-tensor memory availability) associated with the intermediate state data. In an embodiment, the memory availability indicates the available memory capacity for each tensor in the intermediate state data. Block 176 allocates address space on the chip to the intermediate state data. In one example, block 176 determines access scores associated with the intermediate state data, wherein the address space is further allocated based on the access scores. Additionally, block 176 may hierarchically align spatial data flows between output state data (e.g., output feature maps) and input state data (e.g., input feature maps) in the intermediate state data. Block 178 stores the intermediate state data to the allocated address space. The method 170 therefore further enhances performance at least to the extent that allocating address space to the intermediate state data based on the residency data and/or the memory availability addresses concerns over bandwidth bottlenecks, limited capacity of on-chip memories and/or locally produced data tiles not being fully consumed by the same local compute cores/nodes.

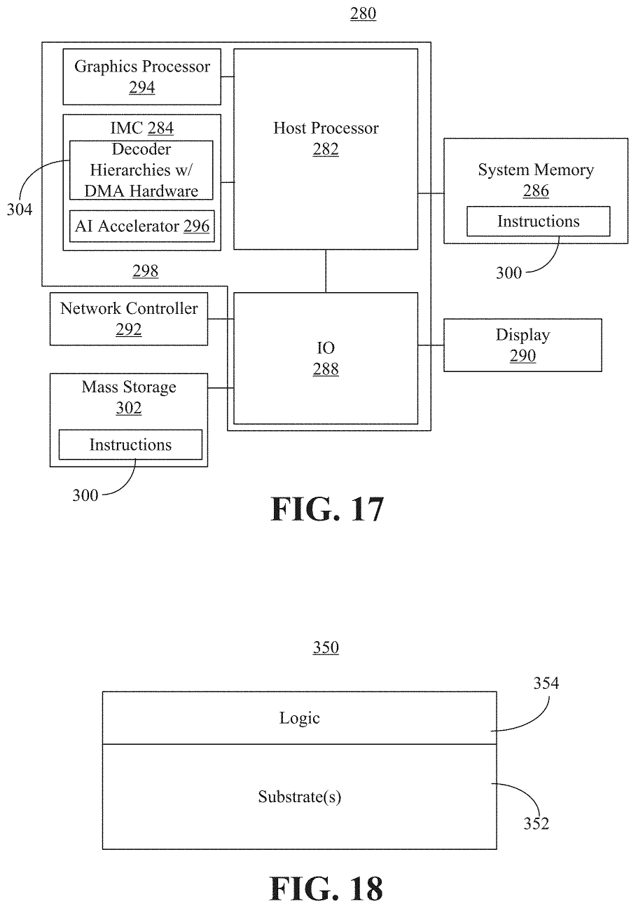

Turning now to FIG. 17, a performance-enhanced computing system 280 is shown. The system 280 may generally be part of an electronic device/platform having computing functionality (e.g., personal digital assistant/PDA, notebook computer, tablet computer, convertible tablet, edge node, server, cloud computing infrastructure), communications functionality (e.g., smart phone), imaging functionality (e.g., camera, camcorder), media playing functionality (e.g., smart television/TV), wearable functionality (e.g., watch, eyewear, headwear, footwear, jewelry), vehicular functionality (e.g., car, truck, motorcycle), robotic functionality (e.g., autonomous robot), Internet of Things (IoT) functionality, etc., or any combination thereof.

In the illustrated example, the system 280 includes a host processor 282 (e.g., central processing unit/CPU) that is coupled to a system memory 286 (e.g., dual inline memory module/DIMM including a plurality of dynamic RAMs/DRAMs) and an integrated memory controller (IMC) 284. In an embodiment, an IO (input/output) module 288 is coupled to the host processor 282. The illustrated IO module 288 communicates with, for example, a display 290 (e.g., touch screen, liquid crystal display/LCD, light emitting diode/LED display), mass storage 302 (e.g., hard disk drive/HDD, optical disc, solid state drive/SSD) and a network controller 292 (e.g., wired and/or wireless). The host processor 282 may be combined with the 10 module 288, a graphics processor 294, and the IMC 284 into a system on chip (SoC) 298. The illustrated IMC 284 includes decoder hierarchies 304 (e.g., including DMA hardware) and an AI accelerator 296 (e.g., compute hardware).

In an embodiment, the IMC 284 is incorporated onto a chip such as, for example, the chip 30 (FIG. 1). Thus, the IMC 284 may include a memory structure (not shown) having the compute hardware of the AI accelerator 296, wherein the decoder hierarchies 304 include a plurality of address decoders coupled to the compute hardware and a hierarchical interconnect fabric coupled to the plurality of address decoders. The DMA hardware of the IMC 284 may be positioned adjacent to one or more of the plurality of address decoders, wherein the DMA hardware conducts on-chip transfers of intermediate state data (e.g., inter-layer data associated with an NN) via the hierarchical interconnect fabric.

The IMC 284 and/or the host processor 282 may also execute instructions 300 (e.g., compiler and/or data flow optimizer instructions) retrieved from the system memory 286 and/or the mass storage 302 to perform one or more aspects of the method 70 (FIG. 4A), the method 72 (FIG. 4B) and/or the method 170 (FIG. 16), already discussed. Thus, execution of the instructions 300 causes the IMC 284, the host processor 282 and/or the computing system 280 to allocate address space in the chip to the intermediate state data and store the intermediate state data to the allocated address space. In an embodiment, the address space is allocated to the intermediate state data based on residency data (e.g., per-layer residency data) and/or memory availability (e.g., per-tensor memory availability).

The computing system 280 and/or the chip containing the IMC 284 are therefore considered performance-enhanced at least to the extent that conducting the on-chip transfers of intermediate state data reduces DRAM (dynamic random access memory) transfers and/or latency during operation. The computing system 280 and/or the chip containing the IMC 284 are also considered performance-enhanced because allocating address space to the intermediate state data based on the residency data and/or the memory availability addresses concerns over bandwidth bottlenecks, limited capacity of on-chip memories and/or locally produced data tiles not being fully consumed by the same local compute cores/nodes.

FIG. 18 shows a semiconductor apparatus 350 (e.g., chip, die, package). The illustrated apparatus 350 includes one or more substrates 352 (e.g., silicon, sapphire, gallium arsenide) and logic 354 (e.g., transistor array and other integrated circuit/IC components) coupled to the substrate(s) 352. In an embodiment, the logic 354 implements one or more aspects of method 70 (FIG. 4A), the method 72 (FIG. 4B), the method 160 (FIG. 15) and/or the method 170 (FIG. 16), already discussed.

The logic 354 may be implemented at least partly in configurable or fixed-functionality hardware. In one example, the logic 354 includes transistor channel regions that are positioned (e.g., embedded) within the substrate(s) 352. Thus, the interface between the logic 354 and the substrate(s) 352 may not be an abrupt junction. The logic 354 may also be considered to include an epitaxial layer that is grown on an initial wafer of the substrate(s) 352.

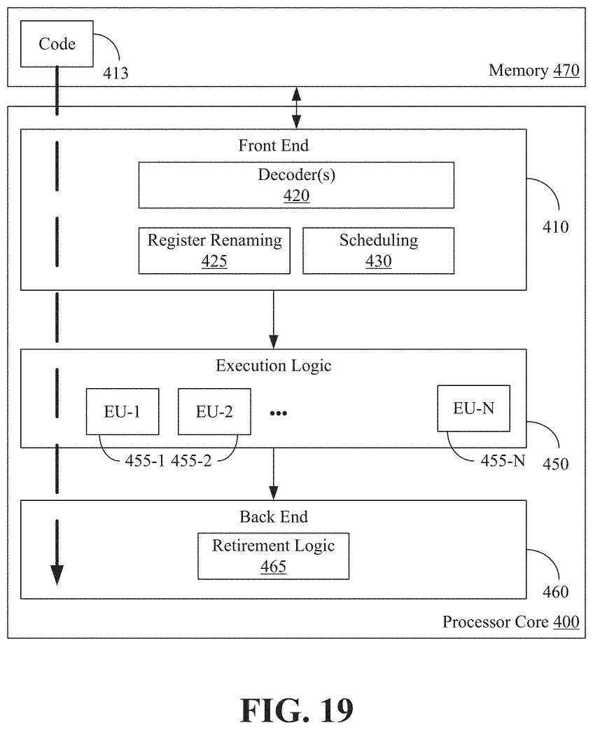

FIG. 19 illustrates a processor core 400 according to one embodiment. The processor core 400 may be the core for any type of processor, such as a micro-processor, an embedded processor, a digital signal processor (DSP), a network processor, or other device to execute code. Although only one processor core 400 is illustrated in FIG. 19, a processing element may alternatively include more than one of the processor core 400 illustrated in FIG. 19. The processor core 400 may be a single-threaded core or, for at least one embodiment, the processor core 400 may be multithreaded in that it may include more than one hardware thread context (or “logical processor”) per core.

FIG. 19 also illustrates a memory 470 coupled to the processor core 400. The memory 470 may be any of a wide variety of memories (including various layers of memory hierarchy) as are known or otherwise available to those of skill in the art. The memory 470 may include one or more code 413 instruction(s) to be executed by the processor core 400, wherein the code 413 may implement the method 70 (FIG. 4A), the method 72 (FIG. 4B) and/or the method 170 (FIG. 16), already discussed. The processor core 400 follows a program sequence of instructions indicated by the code 413. Each instruction may enter a front end portion 410 and be processed by one or more decoders 420. The decoder 420 may generate as its output a micro operation such as a fixed width micro operation in a predefined format, or may generate other instructions, microinstructions, or control signals which reflect the original code instruction. The illustrated front end portion 410 also includes register renaming logic 425 and scheduling logic 430, which generally allocate resources and queue the operation corresponding to the convert instruction for execution.

The processor core 400 is shown including execution logic 450 having a set of execution units 455-1 through 455-N. Some embodiments may include a number of execution units dedicated to specific functions or sets of functions. Other embodiments may include only one execution unit or one execution unit that can perform a particular function. The illustrated execution logic 450 performs the operations specified by code instructions.

After completion of execution of the operations specified by the code instructions, back end logic 460 retires the instructions of the code 413. In one embodiment, the processor core 400 allows out of order execution but requires in order retirement of instructions. Retirement logic 465 may take a variety of forms as known to those of skill in the art (e.g., re-order buffers or the like). In this manner, the processor core 400 is transformed during execution of the code 413, at least in terms of the output generated by the decoder, the hardware registers and tables utilized by the register renaming logic 425, and any registers (not shown) modified by the execution logic 450.

Although not illustrated in FIG. 19, a processing element may include other elements on chip with the processor core 400. For example, a processing element may include memory control logic along with the processor core 400. The processing element may include I/O control logic and/or may include I/O control logic integrated with memory control logic. The processing element may also include one or more caches.

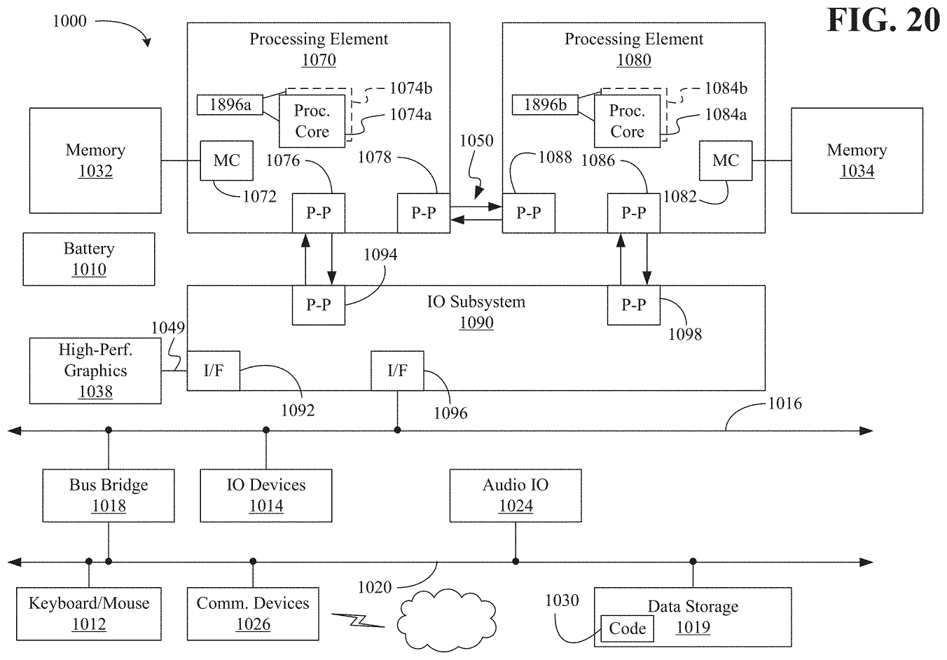

Referring now to FIG. 20, shown is a block diagram of a computing system 1000 embodiment in accordance with an embodiment. Shown in FIG. 20 is a multiprocessor system 1000 that includes a first processing element 1070 and a second processing element 1080. While two processing elements 1070 and 1080 are shown, it is to be understood that an embodiment of the system 1000 may also include only one such processing element.

The system 1000 is illustrated as a point-to-point interconnect system, wherein the first processing element 1070 and the second processing element 1080 are coupled via a point-to-point interconnect 1050. It should be understood that any or all of the interconnects illustrated in FIG. 20 may be implemented as a multi-drop bus rather than point-to-point interconnect.

As shown in FIG. 20, each of processing elements 1070 and 1080 may be multicore processors, including first and second processor cores (i.e., processor cores 1074a and 1074b and processor cores 1084a and 1084b). Such cores 1074a, 1074b, 1084a, 1084b may be configured to execute instruction code in a manner similar to that discussed above in connection with FIG. 19.

Each processing element 1070, 1080 may include at least one shared cache 1896a, 1896b. The shared cache 1896a, 1896b may store data (e.g., instructions) that are utilized by one or more components of the processor, such as the cores 1074a, 1074b and 1084a, 1084b, respectively. For example, the shared cache 1896a, 1896b may locally cache data stored in a memory 1032, 1034 for faster access by components of the processor. In one or more embodiments, the shared cache 1896a, 1896b may include one or more mid-level caches, such as level 2 (L2), level 3 (L3), level 4 (L4), or other levels of cache, a last level cache (LLC), and/or combinations thereof.

While shown with only two processing elements 1070, 1080, it is to be understood that the scope of the embodiments are not so limited. In other embodiments, one or more additional processing elements may be present in a given processor. Alternatively, one or more of processing elements 1070, 1080 may be an element other than a processor, such as an accelerator or a field programmable gate array. For example, additional processing element(s) may include additional processors(s) that are the same as a first processor 1070, additional processor(s) that are heterogeneous or asymmetric to processor a first processor 1070, accelerators (such as, e.g., graphics accelerators or digital signal processing (DSP) units), field programmable gate arrays, or any other processing element. There can be a variety of differences between the processing elements 1070, 1080 in terms of a spectrum of metrics of merit including architectural, micro architectural, thermal, power consumption characteristics, and the like. These differences may effectively manifest themselves as asymmetry and heterogeneity amongst the processing elements 1070, 1080. For at least one embodiment, the various processing elements 1070, 1080 may reside in the same die package.

The first processing element 1070 may further include memory controller logic (MC) 1072 and point-to-point (P-P) interfaces 1076 and 1078. Similarly, the second processing element 1080 may include a MC 1082 and P-P interfaces 1086 and 1088. As shown in FIG. 20, MC's 1072 and 1082 couple the processors to respective memories, namely a memory 1032 and a memory 1034, which may be portions of main memory locally attached to the respective processors. While the MC 1072 and 1082 is illustrated as integrated into the processing elements 1070, 1080, for alternative embodiments the MC logic may be discrete logic outside the processing elements 1070, 1080 rather than integrated therein.

The first processing element 1070 and the second processing element 1080 may be coupled to an I/O subsystem 1090 via P-P interconnects 1076 1086, respectively. As shown in FIG. 20, the I/O subsystem 1090 includes P-P interfaces 1094 and 1098. Furthermore, I/O subsystem 1090 includes an interface 1092 to couple I/O subsystem 1090 with a high performance graphics engine 1038. In one embodiment, bus 1049 may be used to couple the graphics engine 1038 to the I/O subsystem 1090. Alternately, a point-to-point interconnect may couple these components.

In turn, I/O subsystem 1090 may be coupled to a first bus 1016 via an interface 1096. In one embodiment, the first bus 1016 may be a Peripheral Component Interconnect (PCI) bus, or a bus such as a PCI Express bus or another third generation I/O interconnect bus, although the scope of the embodiments are not so limited.

As shown in FIG. 20, various I/O devices 1014 (e.g., biometric scanners, speakers, cameras, sensors) may be coupled to the first bus 1016, along with a bus bridge 1018 which may couple the first bus 1016 to a second bus 1020. In one embodiment, the second bus 1020 may be a low pin count (LPC) bus. Various devices may be coupled to the second bus 1020 including, for example, a keyboard/mouse 1012, communication device(s) 1026, and a data storage unit 1019 such as a disk drive or other mass storage device which may include code 1030, in one embodiment. The illustrated code 1030 may implement the method 70 (FIG. 4A), the method 72 (FIG. 4B) and/or the method 170 (FIG. 16), already discussed. Further, an audio I/O 1024 may be coupled to second bus 1020 and a battery 1010 may supply power to the computing system 1000.

Note that other embodiments are contemplated. For example, instead of the point-to-point architecture of FIG. 20, a system may implement a multi-drop bus or another such communication topology. Also, the elements of FIG. 20 may alternatively be partitioned using more or fewer integrated chips than shown in FIG. 20.

### Additional Notes and Examples

Example 1 includes a performance-enhanced chip comprising a memory structure including compute hardware, a plurality of address decoders coupled to the compute hardware, and a hierarchical interconnect fabric coupled to the plurality of address decoders, and direct memory address (DMA) hardware positioned adjacent to one or more of the plurality of address decoders, wherein the DMA hardware is to conduct on-chip transfers of intermediate state data via the hierarchical interconnect fabric.

Example 2 includes the chip of Example 1, wherein the chip further includes logic coupled to one or more substrates, and wherein the logic is implemented at least partly in one or more of configurable hardware or fixed-functionality hardware, the logic to allocate address space in the chip to the intermediate state data, and store the intermediate state data to the allocated address space.

Example 3 includes the chip of Example 2, wherein the logic is further to determine residency data associated with the intermediate state data, and determine a memory availability associated with the intermediate state data, wherein the address space is allocated based on the residency data and the memory availability.

Example 4 includes the chip of Example 3, wherein the logic is further to determine access scores associated with the intermediate state data, and wherein the address space is further allocated based on the access scores.

Example 5 includes the chip of Example 2, wherein the logic is further to hierarchically align spatial data flows between output state data and input state data in the intermediate state data.

Example 6 includes the chip of Example 2, wherein the logic coupled to the one or more substrates includes transistor regions that are positioned within the one or more substrates.

Example 7 includes the chip of Example 1, wherein the intermediate state data is to be inter-layer data associated with a neural network.

Example 8 includes the chip of Example 1, wherein the memory structure further includes a plurality of memory cell sub-arrays, and wherein the compute hardware includes a plurality of compute cores corresponding to the plurality of memory cell sub-arrays.

Example 9 includes the chip of Example 1, wherein the memory structure includes a memory bit-cell array, and wherein memory bit-cell array includes the compute hardware.

Example 10 includes the chip of any one of Examples 1 to 9, wherein the DMA hardware is restricted to a subset of locations corresponding to the plurality of address decoders.

Example 11 includes a performance-enhanced computing system comprising a network controller, a processor coupled to the network controller, and a chip comprising a memory structure coupled to the processor, wherein the memory structure includes compute hardware, a plurality of address decoders coupled to the compute hardware, and a hierarchical interconnect fabric coupled to the plurality of address decoders, and direct memory access (DMA) hardware positioned adjacent to one or more of the plurality of address decoders, wherein the DMA hardware is to conduct on-chip transfers of intermediate state data via the hierarchical interconnect fabric.

Example 12 includes the computing system of Example 11, wherein the intermediate state data is to be inter-layer data associated with a neural network.

Example 13 includes the computing system of Example 11, wherein the chip further includes a plurality of memory cell sub-arrays, and wherein the compute hardware includes a plurality of compute cores corresponding to the plurality of memory cell sub-arrays.

Example 14 includes the computing system of Example 11, wherein memory structure includes a memory bit-cell array, and wherein the memory bit-cell array includes the compute hardware.

Example 15 includes the computing system of any one of Examples 11 to 14, wherein the DMA hardware is restricted to a subset of locations corresponding to the plurality of address decoders.

Example 16 includes at least one computer readable storage medium comprising a set of instructions, which when executed by a chip, cause the chip to allocate address space in the chip to inter-layer data associated with a neural network, and store the inter-layer data to the allocated address space.

Example 17 includes the at least one computer readable storage medium of Example 16, wherein the instructions, when executed, further cause the chip to determine per-layer residency data associated with the inter-layer data, and determine a per-tensor memory availability associated with the inter-layer data, wherein the address space is allocated based on the per-layer residency data and the per-tensor memory availability.

Example 18 includes the at least one computer readable storage medium of Example 17, wherein the instructions, when executed, further cause the chip to determine access scores associated with the inter-layer data, and wherein the address space is further allocated based on the access scores.

Example 19 includes the at least one computer readable storage medium of any one of Examples 16 to 18, wherein the instructions, when executed, further cause the chip to hierarchically align spatial data flows between output feature maps and input feature maps in the inter-layer data.

Example 20 includes a method of operating a chip, the method comprising allocating address space in the chip to inter-layer data associated with a neural network, and storing the inter-layer data to the allocated address space.

Example 21 includes an apparatus comprising means for performing the method of Example 20.

Example sizes/models/values/ranges may have been given, although embodiments are not limited to the same. As manufacturing techniques (e.g., photolithography) mature over time, it is expected that devices of smaller size could be manufactured. In addition, well known power/ground connections to IC chips and other components may or may not be shown within the figures, for simplicity of illustration and discussion, and so as not to obscure certain aspects of the embodiments. Further, arrangements may be shown in block diagram form in order to avoid obscuring embodiments, and also in view of the fact that specifics with respect to implementation of such block diagram arrangements are highly dependent upon the computing system within which the embodiment is to be implemented, i.e., such specifics should be well within purview of one skilled in the art. Where specific details (e.g., circuits) are set forth in order to describe example embodiments, it should be apparent to one skilled in the art that embodiments can be practiced without, or with variation of, these specific details. The description is thus to be regarded as illustrative instead of limiting.

The term “coupled” may be used herein to refer to any type of relationship, direct or indirect, between the components in question, and may apply to electrical, mechanical, fluid, optical, electromagnetic, electromechanical or other connections. In addition, the terms “first”, “second”, etc. may be used herein only to facilitate discussion, and carry no particular temporal or chronological significance unless otherwise indicated.

As used in this application and in the claims, a list of items joined by the term “one or more of” may mean any combination of the listed terms. For example, the phrases “one or more of A, B or C” may mean A; B; C; A and B; A and C; B and C; or A, B and C.

Those skilled in the art will appreciate from the foregoing description that the broad techniques of the embodiments can be implemented in a variety of forms. Therefore, while the embodiments have been described in connection with particular examples thereof, the true scope of the embodiments should not be so limited since other modifications will become apparent to the skilled practitioner upon a study of the drawings, specification, and following claims.

We claim:

1. A chip comprising:
a memory structure including compute hardware, a plurality of address decoders coupled to the compute hardware, and a hierarchical interconnect fabric coupled to the plurality of address decoders; and
direct memory access (DMA) hardware positioned adjacent to one or more of the plurality of address decoders, wherein the DMA hardware is to conduct on-chip transfers of intermediate state data via the hierarchical interconnect fabric.

2. The chip of claim 1, wherein the chip further includes logic coupled to one or more substrates, and wherein the logic is implemented at least partly in one or more of configurable hardware or fixed-functionality hardware, the logic to:
allocate address space in the chip to the intermediate state data; and
store the intermediate state data to the allocated address space.

3. The chip of claim 2, wherein the logic is further to:
determine residency data associated with the intermediate state data; and
determine a memory availability associated with the intermediate state data, wherein the address space is allocated based on the residency data and the memory availability.

4. The chip of claim 3, wherein the logic is further to determine access scores associated with the intermediate state data, and wherein the address space is further allocated based on the access scores.

5. The chip of claim 2, wherein the logic is further to hierarchically align spatial data flows between output state data and input state data in the intermediate state data.

6. The chip of claim 2, wherein the logic coupled to the one or more substrates includes transistor regions that are positioned within the one or more substrates.

7. The chip of claim 1, wherein the intermediate state data is to be inter-layer data associated with a neural network.

8. The chip of claim 1, wherein the memory structure further includes a plurality of memory cell sub-arrays, and wherein the compute hardware includes a plurality of compute cores corresponding to the plurality of memory cell sub-arrays.

9. The chip of claim 1, wherein the memory structure includes a memory bit-cell array, and wherein memory bit-cell array includes the compute hardware.

10. The chip of claim 1, wherein the DMA hardware is restricted to a subset of locations corresponding to the plurality of address decoders.

11. A computing system comprising:
a network controller;
a processor coupled to the network controller; and
a chip comprising:
a memory structure coupled to the processor, wherein the memory structure includes compute hardware, a plurality of address decoders coupled to the compute hardware, and a hierarchical interconnect fabric coupled to the plurality of address decoders, and
direct memory access (DMA) hardware positioned adjacent to one or more of the plurality of address decoders, wherein the DMA hardware is to conduct on-chip transfers of intermediate state data via the hierarchical interconnect fabric.

12. The computing system of claim 11, wherein the intermediate state data is to be inter-layer data associated with a neural network.

13. The computing system of claim 11, wherein the chip further includes a plurality of memory cell sub-arrays, and wherein the compute hardware includes a plurality of compute cores corresponding to the plurality of memory cell sub-arrays.

14. The computing system of claim 11, wherein memory structure includes a memory bit-cell array, and wherein the memory bit-cell array includes the compute hardware.

15. The computing system of claim 11, wherein the DMA hardware is restricted to a subset of locations corresponding to the plurality of address decoders.

16. At least one computer readable storage medium comprising a set of instructions, which when executed by a chip, cause the chip to:
allocate address space in the chip to inter-layer data associated with a neural network; and
store the inter-layer data to the allocated address space.

17. The at least one computer readable storage medium of claim 16, wherein the instructions, when executed, further cause the chip to:
determine per-layer residency data associated with the inter-layer data; and
determine a per-tensor memory availability associated with the inter-layer data, wherein the address space is allocated based on the per-layer residency data and the per-tensor memory availability.

18. The at least one computer readable storage medium of claim 17, wherein the instructions, when executed, further cause the chip to determine access scores associated with the inter-layer data, and wherein the address space is further allocated based on the access scores.

19. The at least one computer readable storage medium of claim 16, wherein the instructions, when executed, further cause the chip to hierarchically align spatial data flows between output feature maps and input feature maps in the inter-layer data.
